(19) United States
(12) Patent Application Publication
(10) Pub. No.: US 2007/0050782 A1
(43) Pub. Date: Mar. 1, 2007

(54) Loading device for compact disc player

(76) Inventors: Chin-Sung Liu, Hsinchu (TW); Li-Chung Peng, Hsinchu (TW)

Correspondence Address: LIN & ASSOCIATES INTELLECTUAL PROPERTY, P.O. BOX 2339, SARATOGA, CA, 95070-0339, US

(21) Appl. No.: 11/338,183

(22) Filed: Jan. 23, 2006

(30) Foreign Application Priority Data
Aug. 30, 2005 (TW) 094214953

(51) Int. Cl. G11B 17/04

(52) U.S. Cl. 720/601

(57) ABSTRACT

A loading device for CD players is provided, including a tray for receiving a disc. The tray is inside a base, and the tray is driven by a driver inside the base to move along a straight line within the range of the base. One end of the tray has an open support, so that the disc is able to move in the direction parallel with the tray and placed into the support. Each of the facing two side walls of the support is equipped with an elastic retaining element, with the minimum distance between the elastic retaining elements smaller than the diameter of said disc. The locations of the elastic retaining elements are closer to the entrance end of the support than the center of the disc when the disc is entirely placed in the support. That is, the elastic retaining elements are placed within the half outer circle of the disc as to push the disc to move along the tray when the tray moves into the base.

### FIELD OF THE INVENTION

The present invention generally relates to a structure of a compact disc (CD) player, and more specifically to a loading tray device of a slot-in CD player.

### BACKGROUND OF THE INVENTION

The conventional CD players are divided into two types according to the use of loading mechanism. The first type is called tray type, and the second is called slot-in type.

The tray CD player uses a loading tray at the base of the player. The tray can slide out from the base when operated. After the disc is placed on the tray, the tray can slide into the base with the press of a control button or a direct slight nudge at the front edge of the tray. Then, the suppresser device inside the base drags the tray and drives the rotation of the disc. The read-write device reads data from or writes data to the disc. This type of tray CD player has a simple structure, and therefore is less expensive to manufacture. However, because the tray becomes a suspending arm after sliding out from the base, the tray is prone to breakage if accidentally smashed or collided with heavier objects. This becomes a major disadvantage for the tray CD player.

On the other hand, the slot-in CD player uses a design without a tray. The main structure of a slot-in CD player is the complicated mechanical structure inside the base. After the disc is inserted into the slot, the sensor senses the disc and activates the complicated link mechanism to pick up the disc and transfer the disc to a specific position. The suppressor device suppresses the disc and the read-write device reads or writes data. The slot-in CD player has the disadvantage of having a complicated structure and, therefore, is expensive to manufacture.

Although the tray CD is simple in structure and inexpensive to manufacture, the disadvantage of breakage in the tray is a major problem. On the other hand, the slot-in CD player does not have the disadvantage of a suspending and breakable tray, the structure is complicated and is expensive to manufacture. Therefore, it is important to provide a CD play that has the advantages of both types without the disadvantages.

### SUMMARY OF THE INVENTION

The present invention has been made to overcome the above-mentioned respective drawbacks of conventional tray CD player and slot-in CD player. The primary feature of the present invention is the addition of an open support at one end of the tray. The disc can be moved in the direction parallel with the tray and placed into the support. The facing two side walls of the support are equipped with elastic retaining elements. The minimum distance between the two side elastic retaining elements is smaller than the diameter of the disc. When the disc is entirely placed in the support, the locations of the two elastic retaining elements are closer to the entrance end of the support than the center of the disc. Therefore, when the tray is transmitted by the driving device to move inwards inside the base, the elastic retaining elements will push the disc to move along.

The elastic retaining element for pushing the disc can be an elastic body with elasticity, such as rubber, plastic, and so on. The elastic retaining element can also be s spring with ball placed inside the concave of the side walls of the support. By using the springs to extrude the balls from the side walls of the support, the balls form the support to the disc edge to push the disc to move along the tray into the base when the diameter of the disc passes the balls.

With the aforementioned structure, the tray only moves within the range of the base. In addition, because the tray has the elastic retaining elements, the elastic retaining elements will support the disc along the tangent direction once it is inserted, and then transmitted to the base for reading and writing. Therefore, the present invention has the same effect as a slot-in CD player.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a top view of schematic layout of a CD player of the present invention;

FIG. 2 shows a top view of schematic layout of the support of the tray of the present invention;

FIG. 3 shows a schematic view of the elastic retaining element pushing the disc into the base as the tray moving inwards the base; and

FIG. 4 shows a schematic view of another embodiment of the elastic retaining element in the side wall of the support of the present invention.

### DETAILED DESCRIPTION OF THE PREFERRED EMBODIMENTS

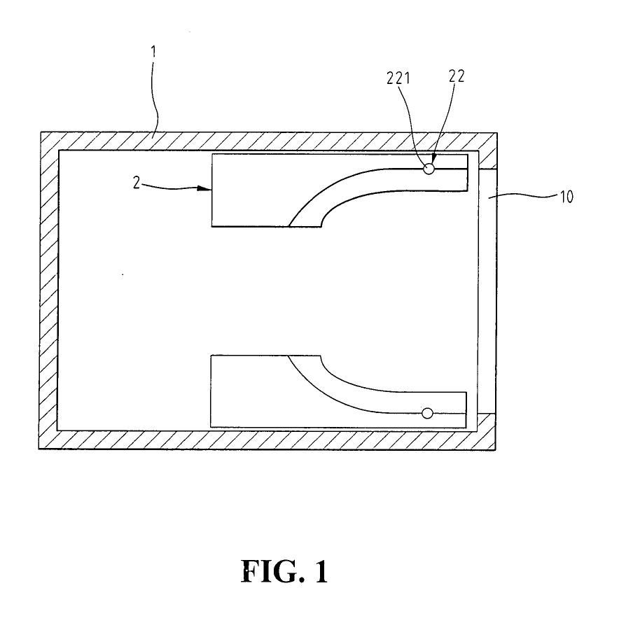

FIG. 1 shows a disc loading device, including a base 1 having a tray 2. Tray 2 is driven by a driving device (not shown) which is installed in base 1 and located under tray 2 so that tray 2 can move along a straight line within the range of base 2.

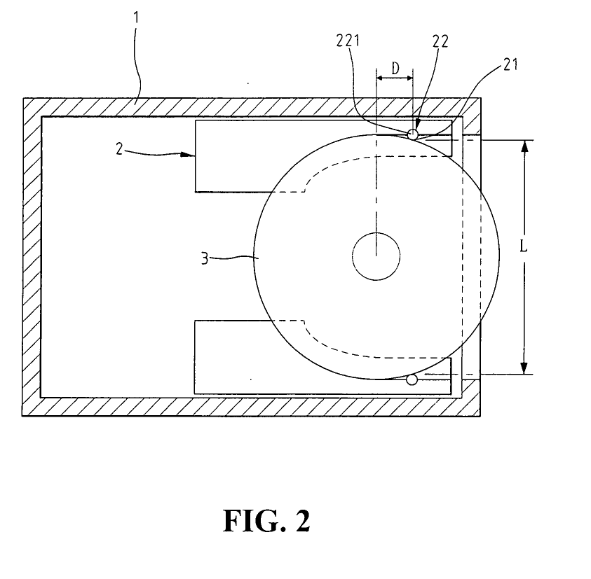

The end of tray 2 facing a disc slot 10 of base 1 has a support 21. Support 21 is preferably in the form of U-shaped concave region. The opening of the U-shape faces slot 10 of base 1 so that disc 3 can be moved in the direction parallel to tray 2 and placed into support 21, as shown in FIG. 2. The bottom end of the U-shape has the curviness matching that of disc 3 so that disc 3 fits support 21 when placed inside support 21. Support 21 can also be other shapes, such as a straight-angled U-shape, as long as it has an opening for inserting the disc.

Each of the opposite two side walls of support 21 has an elastic retaining element 22. The distance L between two elastic retaining elements is less than the diameter of disc 3. When disc 3 is entirely placed in support 21, the locations of two elastic retaining elements 22 are closer to the entrance end of support 21 than the center of disc 3. That is, there exists a distance D between elastic retaining elements 22 and the center of disc 3.

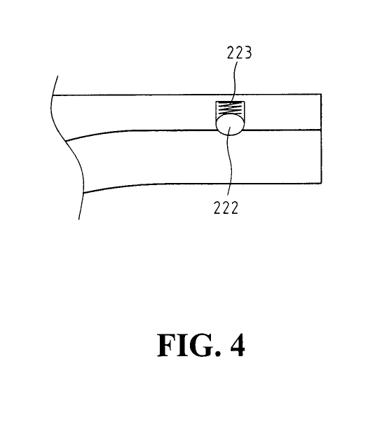

Elastic retaining element 22 of the present invention can be an elastic body 221, such as rubber, plastic, and so on, embedded in the two facing side walls of support 21. It is preferably that elastic retaining element 22 has a sphere surface or cylindrical elastic body. FIG. 4 shows another embodiment of elastic retaining element 22 of the present invention. Elastic retaining element 22 includes a ball 222 and a spring 223. Ball 222 and spring 223 are placed inside the concave of the facing side walls of support 21. with ball 222 extruding the concave so that the distance between two balls 222 is less than the diameter of disc 3.

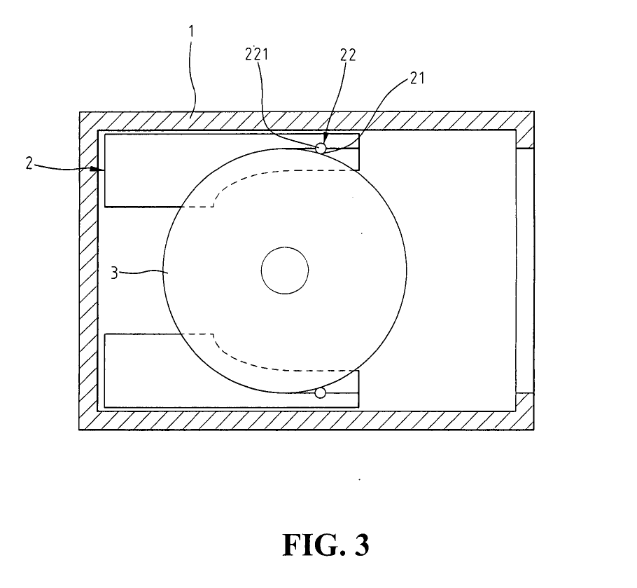

FIG. 3 shows the operation of the present invention. When the user intends to insert disc 3 into the CD player, the user presses the button and tray 2 moves close to the location of slot 10 of base 1. The user inserts disc 3 through slot 10 into support 21 of tray 2. As the diameter of disc 3 is larger than the distance L between two elastic retaining elements 22 which have elasticity, the user must slightly push disc 3 so that the diameter of disc 3 can pass through two elastic retaining elements 22. Once disc 3 passes through elastic retaining elements 22 and is entirely placed in support 21, the distance D between elastic retaining elements 22 and the center of disc 3 will make elastic retaining elements 22 forming a support effect on the edge of disc 3. When the user presses the button again, or slightly push disc 3 to move tray 2 along, the sensor (not shown) inside base 1 senses the movement of tray 2 and activates the driver to drive tray 2 into base 1. At the same time, elastic retaining elements 22 push the edges of disc 3 to move along tray 2 into base 1. After disc 3 reaches a specific location, tray 2 and disc 3 separate and the suppressor device inside base 1 holds and rotates disc 3 in location. At this point, the read-write device can either read data from disc 3 or write data into disc 3. The driver, the sensor and the read-write device are similar to those used in conventional CD players.

Although the present invention has been described with reference to the referred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A loading device for CD players, comprising a tray for receiving a disc, said tray being inside a base, said tray driven by a driver inside said base to move along a straight line within the range of said base;
wherein one end of said tray having an open support, said disc able to move in the direction parallel with said tray and placed into said support, each of the facing two side walls of said support equipped with an elastic retaining element, with the minimum distance between said elastic retaining elements smaller than the diameter of said disc, the locations of said elastic retaining elements being closer to the entrance end of said support than the center of said disc when said disc being entirely placed in said support.

2. The device as claimed in claim 1, wherein said support is a U-shaped concave region formed at one end of said tray.

3. The device as claimed in claim 1, wherein said elastic retaining element is a rubber body embedded inside the two facing walls of said support.

4. The device as claimed in claim 3, wherein the surface of said rubber body is a sphere.

5. The device as claimed in claim 3, wherein the shape of said rubber body is cylindrical.

6. The device as claimed in claim 1, wherein said elastic retaining body further comprises a ball and a spring, embedded inside a concave on each of facing side walls of said support with said balls extruding said side walls.
